(19) United States
(12) Patent Application Publication
(10) Pub. No.: US 2015/0090651 A1
(43) Pub. Date: Apr. 2, 2015

(54) Fuel Filter Cartridge and Method of Use Thereof

(71) Applicant: Stanadyne Corporation, Windsor, CT (US)

(72) Inventors: Chandrakant Siddharam Kotale, Manchester, CT (US); Kenneth W. Dutil, Farmington, CT (US)

(73) Assignee: Stanadyne Corporation, Windsor, CT (US)

(21) Appl. No.: 14/043,953

(22) Filed: Oct. 2, 2013

(51) Int. Cl. B01D 27/08; F02M 37/22

(52) U.S. Cl. CPC B01D 27/08; F02M 37/221
USPC 210/232; 210/450; 29/426.2

(57) ABSTRACT

A filter cartridge in accordance with the present disclosure has a longitudinal axis and comprises a housing, a filter element, and a collar. The housing has a generally cylindrical sidewall and defines an open first end, an axially opposite second end, and a flange projecting radially away from the axis at the first end. The filter element has a ring of filter media circumscribing the axis and extending between first and second end caps. The first end cap has a generally cylindrical wall extending axially between first and second peripheral rims. The wall defines first and second seal glands adjacent the first and second rims which receive first and second seal members, respectively. A ledge projects radially outwardly from the cylindrical wall. The collar has an annular sidewall having a shoulder projecting from an inner surface. The ledge and the shoulder radially overlap and retain the flange therebetween.

### BACKGROUND OF THE DISCLOSURE

The present disclosure relates generally to devices for filtering and separating liquids. More particularly, the present disclosure relates to fuel filters for removing foreign particles and separating water from fuel in an internal combustion engine.

It is well-documented that significant quantities of contaminants such as water and various abrasive particles are found in diesel fuel. In addition to corroding metal components, water may obstruct the fuel lines when environmental temperatures fall below freezing. Likewise, abrasive particles may damage sensitive engine components such as the fuel injection pump.

Fuel filter cartridges are a well-known solution for removing water and abrasive particles from diesel fuel before the fuel is pumped into sensitive engine systems. Prior art fuel filter cartridges typically have a housing having a threaded or bayonet-type connection to a filter base. The housing typically comprises two housing portions joined at a peripheral shoulder, one of which defines an axial opening to provide fuel communication between the filter base and a filter element disposed within the housing. Customarily, fuel filter cartridges are either replaceable as an entire unit, or the filter element may be coupled to the housing such that the filter unit may be individually replaced.

### SUMMARY

Briefly stated, a fuel filter cartridge in connection with the current disclosure comprises a housing, a filter element and a collar. The housing has a generally cylindrical sidewall and defines an open first end and an axially-opposite second end. The sidewall has inner and outer surfaces and a flange which projects radially away from the outer surface at the first end.

The filter element includes a ring of filter media, which circumscribes the longitudinal axis. The media extends axially between first and second end caps. The first end cap defines a fluid flow opening coaxial with the longitudinal axis. A generally cylindrical wall extends axially between first and second peripheral rims, is disposed at a circumferential periphery of the first end cap, and defines first and second seal glands adjacent the first and second peripheral rims, respectively. The first and second seal glands are oriented radially away from the longitudinal axis and receive first and second seal members. A ledge projects radially outwardly from the cylindrical wall intermediate the first and second peripheral rims.

The collar has an annular sidewall, including first and second axial ends. A circumferential shoulder which projects from an inner surface of the sidewall intermediate the first and second axial ends radially overlaps with the upper end cap ledge. The collar circumscribes the housing, and the ledge and the shoulder cooperate to trap the flange. In one embodiment, a wave spring received in a circumferential pocket defined by the collar provides additional axial retention.

A method of using the filter cartridge of the current disclosure is also contemplated. Briefly stated, the method comprises dismounting the filter cartridge from a filter base, disengaging the first end cap and collar, axially withdrawing the filter element from the housing, axially inserting a replacement element, reengaging the first end cap of the replacement element with the collar, and remounting the filter cartridge to the base.

The filter cartridge is dismounted from the filter base by uncoupling a connection between the collar and a skirt of the filter base. Uncoupling the filter cartridge and the base breaks a first seal between the first seal member and an inner surface of the filter base skirt. In one embodiment dismounting the filter cartridge from the base comprises uncoupling a threaded connection, while one alternative embodiment may involve uncoupling a bayonet connection. The remounting step involves reversing the dismounting step, coupling the connection between the collar and the skirt, thereby creating the first seal.

Disengaging the first end cap and the collar includes breaking a second seal between the second seal member and the inner surface of the housing. Engaging the ledge of the replacement filter element and the shoulder of the collar traps the flange of the housing between the ledge and the shoulder.

In one embodiment engaging the ledge and shoulder comprises coupling male and female portions of a threaded connector system, the male portion disposed on the cylindrical wall and the female portion defined on the inner surface of the collar. In another embodiment the engaging step involves coupling a bayonet connection between the cylindrical wall and the collar.

The apparatus and method of the present disclosure provides advantages over and relative to the prior art. For example, the composite filter is easy to manufacture, yet the structural features of the filter element, housing and collar ensure that the connection between the components is robust enough to resist the adverse effects of engine or road vibration. Furthermore, the first and second seal members provide strong seals with the filter base and the inner surface of the housing.

### BRIEF DESCRIPTION OF THE DRAWING

Aspects of the preferred embodiment will be described in reference to the Figures, where like numerals reflect like elements:

FIG. 1 shows a cross-sectional view of one embodiment of a filter cartridge of the present disclosure;

FIG. 2 shows an enlarged cross-sectional view of one embodiment of a connection between a collar, a housing and a first end cap;

FIG. 3 shows a cross-sectional view of one embodiment of the collar of the assembly of FIGS. 1 and 2;

FIG. 4 shows an enlarged cross-sectional view of an alternate embodiment of the connection between the collar, the housing and the first end cap;

FIG. 5 shows a cross-sectional view of an alternate embodiment of the collar of the assembly of FIG. 4;

FIG. 6 shows an enlarged cross-sectional view of the collar shown in FIG. 5 with particular emphasis on an axial slot, a circumferential pocket and a barb;

FIG. 7 shows an enlarged cross-sectional view of an alternate embodiment of the connection between the collar, the housing and the first end cap;

FIG. 8 shows a cross-sectional view of an alternate embodiment of the collar of the assembly of FIG. 7;

FIG. 9 shows an enlarged cross-sectional view of the collar of FIG. 8 with particular emphasis on a female portion of a threaded connector system and slots defined between snap fingers at a first axial end of the collar;

FIG. 10 shows an enlarged cross-sectional view of an alternate embodiment of the connection between the collar, the housing and the first end cap;

FIG. 11 shows a cross-sectional view of an alternate embodiment of the collar of the assembly of FIG. 10;

FIG. 12 shows an enlarged cross-sectional view of the collar of FIG. 11 with particular emphasis on a circumferential pocket, female portion of a threaded connector system and slots defined between snap fingers at a first axial end of the collar;

FIG. 13 shows a cross-sectional view of an alternate embodiment of the filter element;

FIG. 14 shows a perspective view of a second end cap of the filter element of FIG. 13;

FIG. 15 shows an enlarged cross-sectional view of a connection between the housing and the second end cap;

FIG. 16 shows a top-plan view of one embodiment of the housing;

FIG. 17 shows a cross-sectional view of an alternate embodiment of the housing;

FIG. 18 shows an enlarged cross-sectional view of the embodiment of the housing depicted in FIG. 17 with particular emphasis on a ring between a seat and an open first end of the housing;

FIG. 19 shows a cross-sectional view of one embodiment of the filter cartridge as installed with a compatible filter base; and

FIG. 20 shows a perspective view of one embodiment of a wave spring in accordance with certain aspects of the present disclosure.

### DETAILED DESCRIPTION OF THE PREFERRED EMBODIMENT

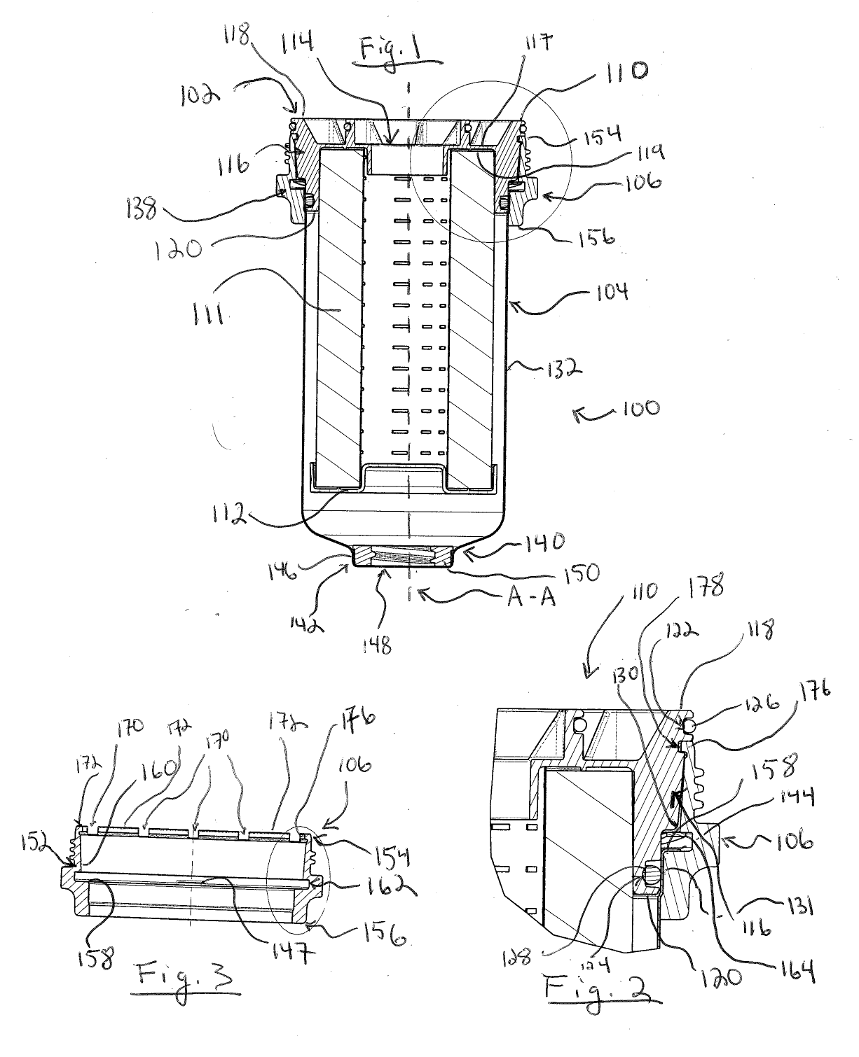

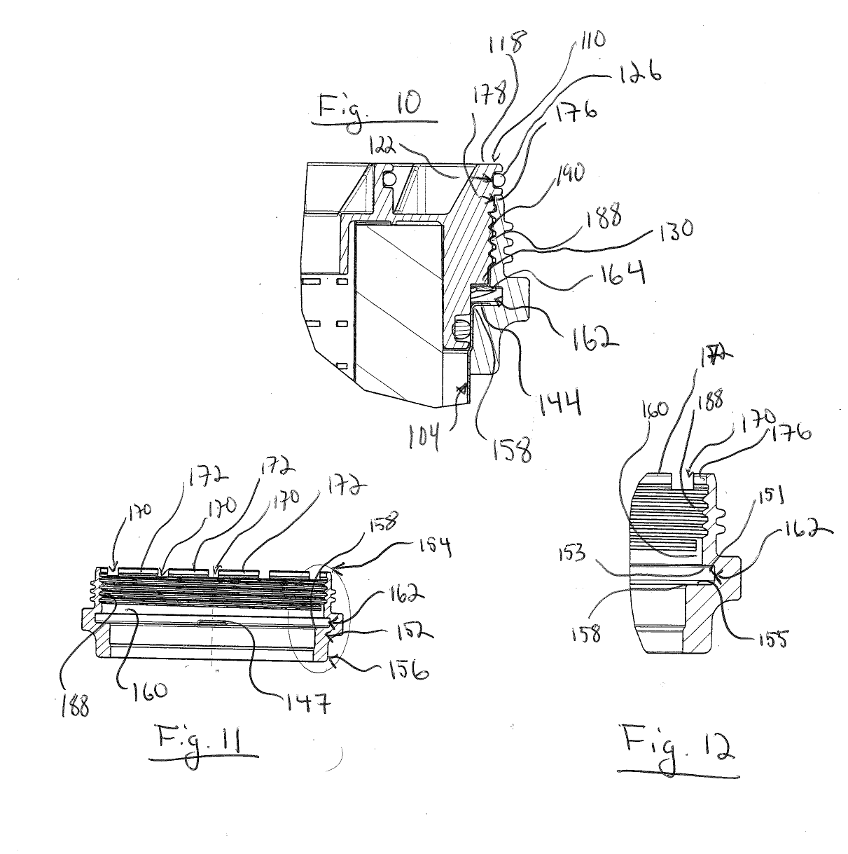

Embodiments of a filter cartridge will now be described with reference to the Figures, wherein like numerals represent like parts throughout the FIGS. 1-20. FIG. 1 illustrates one embodiment of a filter cartridge 100 according to aspects of the disclosure. The filter cartridge 100 has a longitudinal axis A-A and includes a filter element 102, a housing 104 and a collar 106. The filter cartridge 100 is contemplated for use with a filter base 108 (see FIG. 19).

The filter element 102 includes first and second end caps 110 and 112, respectively. The first end cap 110 defines a fluid flow opening 114 coaxial with the longitudinal axis A-A. As also shown in FIG. 2, a generally cylindrical wall 116 is disposed at a circumferential periphery of the first end cap 110. The first end cap 110 includes first and second surfaces 117 and 119, respectively, which extend between the circumferential periphery and the fluid flow opening 114.

The cylindrical wall 116 extends between a first and second peripheral rim 118 and 120, respectively, and defines first and second seal glands 122 and 124, respectively. In the embodiment shown in FIGS. 1 and 13, the cylindrical wall 116 of the upper end cap 110 tapers between the first and second peripheral rims 118 and 120. The first and second seal glands 122 and 124 are respectively defined adjacent the first and second peripheral rims 118 and 120, and oriented radially away from the longitudinal axis A-A. The first and second seal glands 122 and 124 receive first and second seal members 126 and 128, respectively. A ledge 130 projects radially outwardly from the cylindrical wall 116 intermediate the first and second peripheral rims 118 and 120.

In one embodiment best seen in FIG. 19, an annular inner wall 121 projects axially away from the first end cap 110 first surface 117. The annular inner wall is disposed adjacent the fluid flow opening 114 and radially inward of and concentric with the cylindrical wall 116. A third seal gland 123 is oriented radially away from the longitudinal axis A-A, and sized to receive a third seal member 125. The inner wall 121 and third seal gland 123 are configured to sealingly mate with a fuel conduit 107 of the filter base 108. The fuel conduit is disposed radially inwardly of a skirt 109 which sealingly mates with the first seal member 126.

Fuel entering the filter base 108 flows from inlet ports 127 as designated by the arrows. The first seal between the first seal member 126 and the skirt 109 prevents fuel leaking out between the first end cap 102 collar 105 and skirt 109. “Dirty” fuel flows into a plurality of filter ports 129 defined at the circumferential periphery, and subsequently into a space between the filter media 111 and a generally cylindrical housing sidewall 132. Water and other abrasive impurities are filtered from the “dirty” fuel as the fuel flows through the filter media 111, and filtered “clean” fuel flows through the fluid flow opening 114 and out the fuel filter base 108. The third seal between the third seal member 125 and the fuel conduit 107 separates filtered “clean” fuel destined for the fuel injectors and/or other downstream engine components from “dirty” fuel pumped in from the fuel tank.

Referring to FIGS. 1 and 17, the sidewall 132 is coaxial with the longitudinal axis A-A. The sidewall 132 has inner and outer surfaces 134 and 136 and defines an open first end 138 and an axially-opposite second end 140. A flange 144 projects radially away from the outer surface 136 at the open first end 138. As will be described in further detail below, the flange cooperates with the first end cap 110 and the collar 106 to retain the filter element 102 within the housing 104.

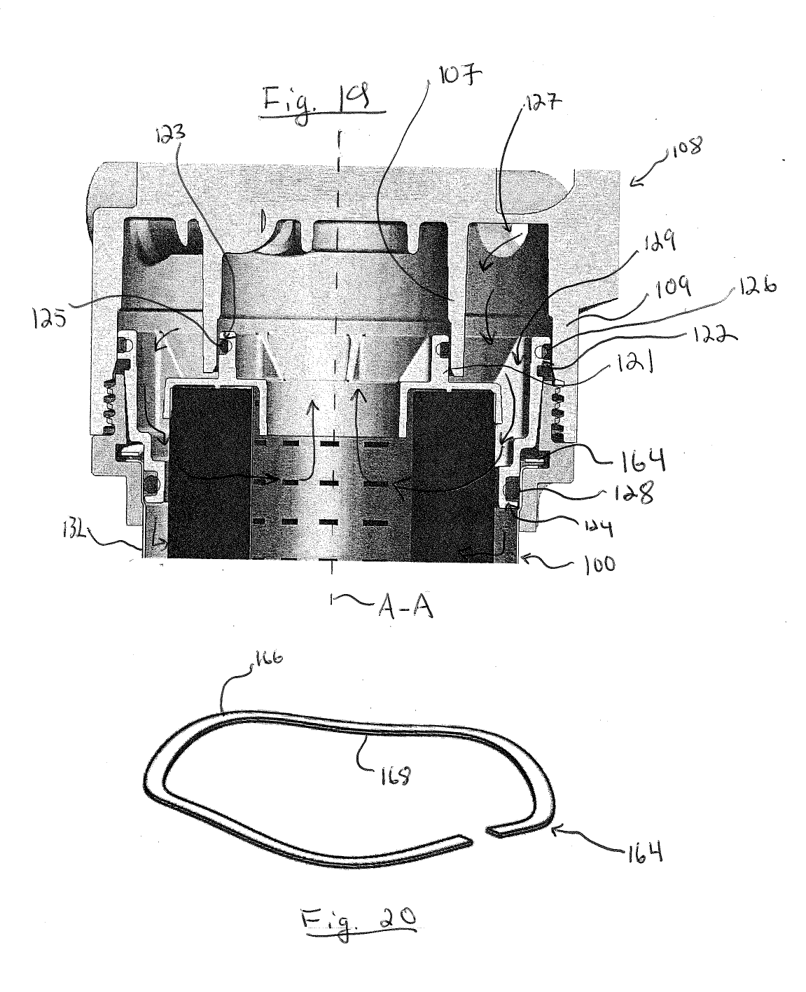

The second seal member 128 creates a second seal with the inner surface of the sidewall 134, fluidly sealing the cartridge and preventing leakage between the first end cap 110 and the housing 104. In the embodiment shown in FIGS. 17 and 18, the sidewall 132 of the housing 104 flares slightly radially outwardly adjacent the first open end 138. A ring 131 of the sidewall 132 located at the radially outward flare is disposed between a seat 133 and the first open end 138, and the inner surface 134 of the ring 131 creates the second seal with the second seal member 128. The seat 133 and first end cap cylindrical wall 116 are configured such that the seat 133 supports the second peripheral rim 120, thereby axially supporting the filter element 102 within the housing 104.

In the embodiment shown in FIGS. 1 and 17, the housing second end 140 defines a drain 142. The drain 142 has generally cylindrical sides 146 and defines a drain port 148. As shown in FIG. 1, the drain sides 146 and the drain port 148 may receive a cylindrical washer 150 which is configured to mate with a valve (not shown) via a threaded, bayonet, or similar connector system.

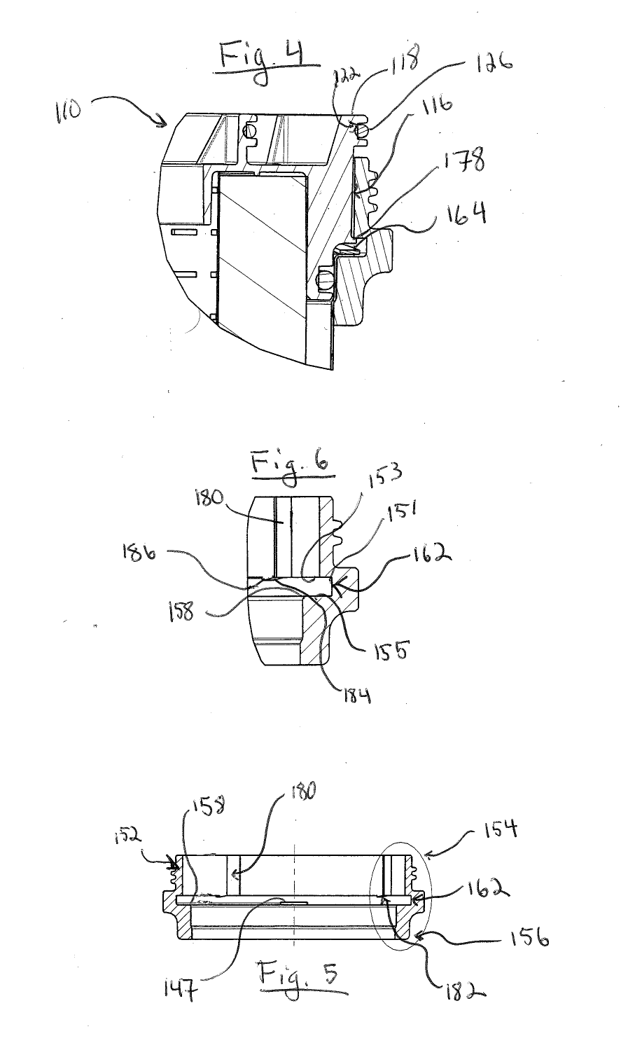

As shown in FIG. 16, the flange may define an aperture 145 configured to receive an anti-rotation member 147 projecting from the circumferential shoulder 158 of the collar 106 (see FIGS. 3, 5, 8 and 11). The anti-rotation member 147 is preferably a raised projection having a rectangular sectional configuration. The aperture 145 and anti-rotation member 147 cooperate to rotationally secure the housing 104 within the collar 106 and ensure that the housing does not rotate relative to the collar 106.

Referring to FIGS. 3, 5, 8 and 11, the collar 106 includes an annular sidewall 152 having first and second axial ends 154 and 156, respectively. A shoulder 158 projects radially inwardly from an inner surface 160 of the annular sidewall 152 axially intermediate the first and second axial ends 154 and 156. The annular sidewall 152 is sized to receive and circumscribe the sidewall 132 of the housing 104, while the shoulder 158 of the collar 106 and the ledge 130 of the upper end cap 110 are sized to radially overlap. The radial overlap between the ledge 130 and the shoulder 158 traps the flange 144 between the two structures (see FIGS. 2, 4, 7 and 10). The filter element 102 is thus axially supported within the cartridge 100 by the upper end cap 110. As will be discussed in further detail below, a plurality of embodiments are contemplated to provide a connection between the element 102, housing 104 and/or collar 106. The connection further secures the element 102 within the cartridge 100 and prevents relative movement between the components.

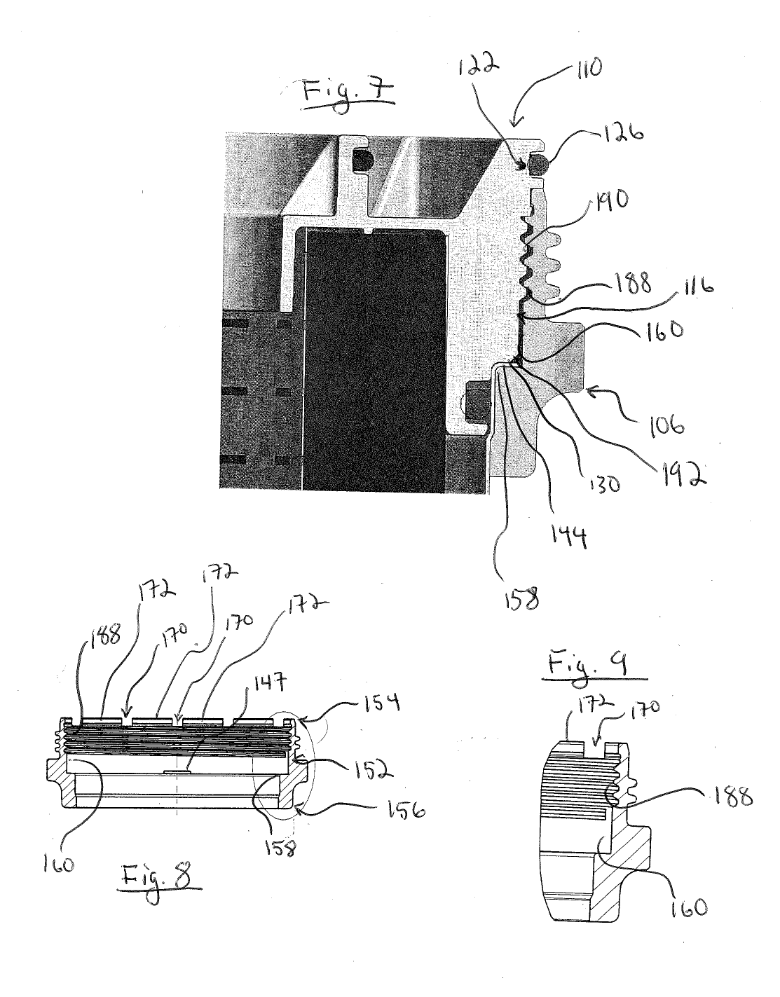

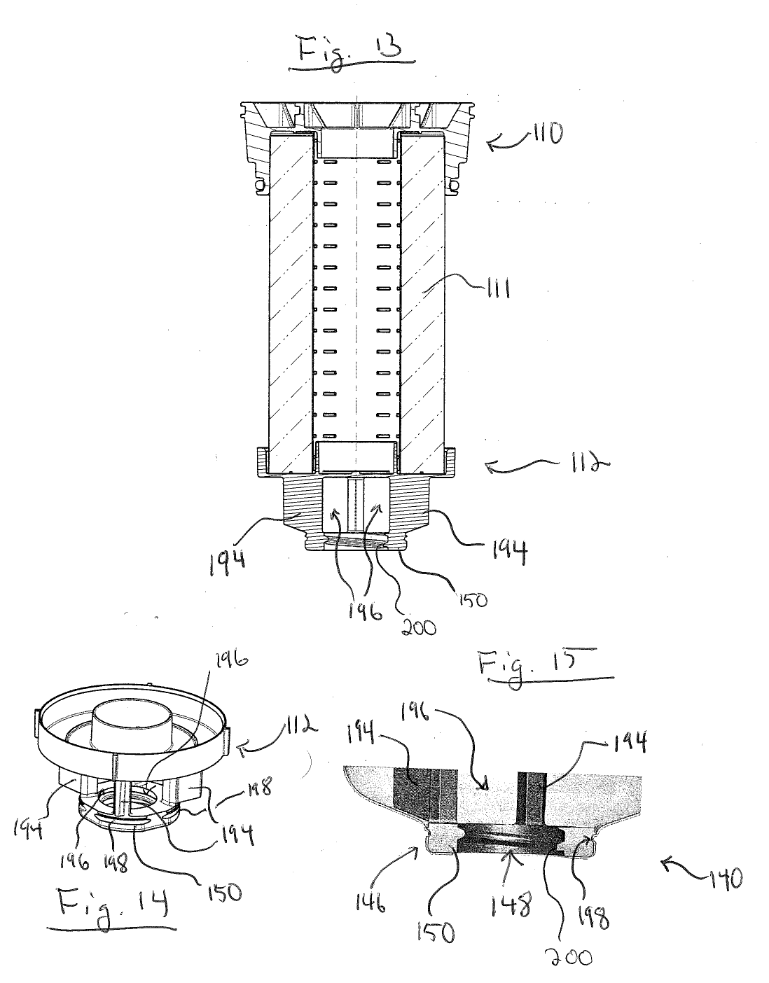

In one embodiment shown in FIGS. 6 and 12, an axially-oriented surface 151 extends between first and second radially-oriented surfaces 153 and 155, respectively, intermediate the first and second axial ends 154 and 156. The axially-oriented surface and first and second radially-oriented surfaces 153 and 155 define a circumferential pocket 162. The second radially-oriented surface 155 is contiguous with the shoulder 158.

As shown in FIGS. 2, 4, 10 and 19, the pocket 162 may receive a wave spring 164. Referring to FIG. 20, the wave spring 164 undulates between a plurality of crests 166 and a plurality of troughs 168. The crests and troughs 166 and 168 secure the wave spring 164 partially radially within pocket 162. The crests 166 also engage the ledge 130 and the crests 168 engage the flange 144 and provide axial forces to secure the housing 104 against the second radially-oriented wall 155 and the shoulder 158.

A number of different embodiments for securing the filter element 102, the housing 104 and the collar 106 are also contemplated in connection with the present disclosure. FIGS. 1-3 show an embodiment where a snap connector system is provided between the filter element 102 to the collar 106; FIGS. 4-6 show an embodiment where a bayonet connection is provided between the filter element 102 to the collar 106; FIGS. 7-9 show an embodiment where a threaded connection is provided between the filter element 102 to the collar 106; FIGS. 10-12 show an alternate embodiment of the threaded connection depicted in FIGS. 7-9; and FIGS. 13-15 show an embodiment where a crimped connection is provided between the filter element 102 and the housing 104.

### I. The Embodiments of FIGS. 1-3

As shown in FIGS. 1-3, a snap connector system secures the upper end cap 110 to the collar 106. Referring specifically to FIG. 3, a plurality of axial slots 170 separate snap fingers 172 projecting from the collar first axial end 154.

The snap connector mating system includes a male and a female connector portion, 174 and 176, respectively. In the embodiment shown in FIGS. 2 and 3, the male snap connector portion 174 projects from the snap fingers 172 radially toward the longitudinal axis A-A, while the female connector portion 176 is defined on an outer surface of the cylindrical wall 116 and oriented radially away from the longitudinal axis A-A. In another embodiment of the snap connector mating system (not shown), the female connector portions 176 is defined on the snap fingers 172 and the male snap connector portion projects radially away from the outer surface of the cylindrical wall 116.

Once the male snap connector portion 174 engages the female snap connector portion 176, the upper end cap 110, the collar 106 and the housing 104 cooperate to secure the filter element within the housing. In the embodiment where a wave spring 164 is received in a circumferential pocket 162, the wave spring crests and troughs 166 and 168 provide additional axial forces securing the flange 144 against the shoulder 158. The wave spring 164 secures the collar 106 to the housing 104.

The snap connector mating system provides a robust connection between the filter element 102 and the collar 106. In the embodiment shown in FIGS. 1-3, the male and female snap connector portions 174 and 176 are configured such that the filter element 102 cannot be replaced once the male snap connector portion 174 engages the female snap connector portion 176 without breaking the snap fingers 172. One of ordinary skill in the art will appreciate that subtle changes in the structural configuration of the male and female snap connector portions 174 and 176 and/or the collar 106 will produce a cartridge 100 that is replaceable once the consumable filter element 102 has reached the end of its usable lifespan.

The collar 106 supports the cartridge 100 relative to the base 108, so the base/cartridge connection is not dependent upon the snap connector.

### II. The Embodiments of FIGS. 4-6

In the embodiments shown in FIGS. 4-6, a bayonet connection secures the upper end cap 110 to the collar 106. The bayonet connector is configured for use with the embodiment of the collar 106 defining the circumferential pocket 162. As shown in FIG. 4, a plurality of tabs 178 project radially outwardly from the cylindrical wall 116. Referring to FIGS. 5 and 6, a corresponding plurality of axially oriented slots 180 are defined on an inner surface of the collar 106.

The axial slots 180 communicate with the circumferential pocket 162. A plurality of barbs 182 project into the pocket 162 from the first radially-oriented surface 153 at the point of communication between the axial slots 180 and the pocket 162. Referring specifically to FIG. 6, each barb 182 includes a ramp surface 184 and a retention shoulder 186.

In the embodiment shown in FIG. 4, the wave spring 164 provides additional axial retention forces, which urge the tabs 178 against the first radially-oriented surface 153. The wave spring 164 ensures that the tabs 178 are secured within the pocket 162, and cooperate with the barbs 182 to prevent the first end cap 110 from rotating past the retention shoulder 186 and disengaging the firs end cap 110 from the collar 106.

To engage the ledge 130 with the shoulder 158 and trap the flange 144, the tabs 178 are first inserted into the axially oriented slots 180. The first end cap 110 is subsequently axially pushed until the tabs 178 are received in the pocket 162. Once the pocket 162 receives the tabs 178, the first end cap 110 is rotated until the tabs 178 ride up the ramp surface 184 and past the retention shoulder 186. As the tabs 178 ride up the ramp surface 184, the tabs 178 and the ledge 158 axially compress the wave spring 164. Once the tabs 178 rotate past the retention shoulder 186 the wave spring 164 rebounds, urging the ledge 158 and tabs 178 against the first radially-oriented surface 153, and urging the flange 144 against the second radially-oriented surface 155. To disengage the first end cap 110 from the collar 106, the previously mentioned steps are sequentially repeated in reverse-order.

### III. The Embodiments of FIGS. 7-9

In the embodiments shown in FIGS. 7-9 a threaded connector system secures the upper end cap 110 to the collar 106. The inner surface 160 of the collar defines a female portion 188 of the threaded connector system. A male portion 190 of the threaded connector system projects from the cylindrical wall 116.

A chamfer 192 is provided between the ledge 130 and the cylindrical wall 116. The chamfer 192 aids in installation of a replacement filter element 102. A sharp transition between the ledge 130 and the cylindrical wall 116 may catch the first axial end 154 or the inner surface 160 of the collar 106 during axial insertion of the element 102 or engagement of the male and female connector portions 188 and 190. Thus, the chamfer 192 ensures that axially inserting of the replacement element 102 within the housing 104 and engagement of the threaded connector system between the upper end cap 110 and the collar 106 is relatively smooth.

In the embodiment shown in FIGS. 7-9, the collar 106 also includes the axial slots 170 defined between the snap connector fingers 172. Male and female snap connector portions 176 and 178, similar to those provided in the embodiment of FIGS. 1-3, are also included. In comparison with the snap connector system shown in FIGS. 1-3, the male snap connector portion 176 and the female snap connector portion 178 are shorter and shallower in the embodiment of FIGS. 7-9. A detent and a corresponding receptacle (not shown) may alternatively be provided on the snap fingers 172 and the cylindrical wall 116, respectively. The snap connector system provides positive feedback during engagement of the threaded connector system. When the male and female connector portions 188 and 190 are completely engaged, the male snap connector portion 176 will simultaneously engage the female snap connector portion 178, providing an audible and tactile indication that the first end cap 110 is completely engaged with the collar 106.

### IV. The Embodiments of FIGS. 10-12

The embodiments shown in FIGS. 10-12 employ a similar threaded connector system to the one depicted in FIGS. 7-9. The collar 106 in the embodiment of FIGS. 10-12 includes the pocket 162 and wave spring 164 in addition to the snap fingers 172, and male and female connector portions 188 and 190. The wave spring 164 secures the collar 106 to the housing 104.

As seen in FIG. 10, the shoulder 130 of the first end cap 110 has a sharper transition than the chamfer 192 shown in the embodiment in FIGS. 7-9. While the shoulder 130 may have a chamfer 192, the shoulder 130 in the embodiment shown in FIG. 10 projects from the cylindrical wall 116 axially closer to the first peripheral rim 118 to accommodate the wave spring 164.

### V. The Embodiments of FIGS. 13-15

As seen in FIGS. 13-15, a crimped connection may secure the filter element 102 within the housing 104. Preferably, it is the second end of the housing 140 which is crimped to axially secure the filter element 102 within the housing 104. An alternate embodiment of the second end cap 112 best seen in FIGS. 13 and 14 creates a strong connection between the filter housing 104 and the filter element 102. A plurality of supports 194 project axially away from the second end cap 112. The supports 194 may comprise struts, or fins, or other similar structural feature which axially position the filter element 102, and define fuel flow paths 196 between the supports 194, allowing water run-off from the filter media 111 to pass through the drain port 148.

The supports 194 are connected to the cylindrical washer 150 axially opposite the filter second end cap 112. The washer 150 defines a radially-outwardly facing circumferential groove 198. The cylindrical sides 146 of the drain 142 receive the washer 150. The sidewalls 146 of the drain are crimped into the circumferential groove 198, retaining the filter element 102 within the housing 104 at the second end 140.

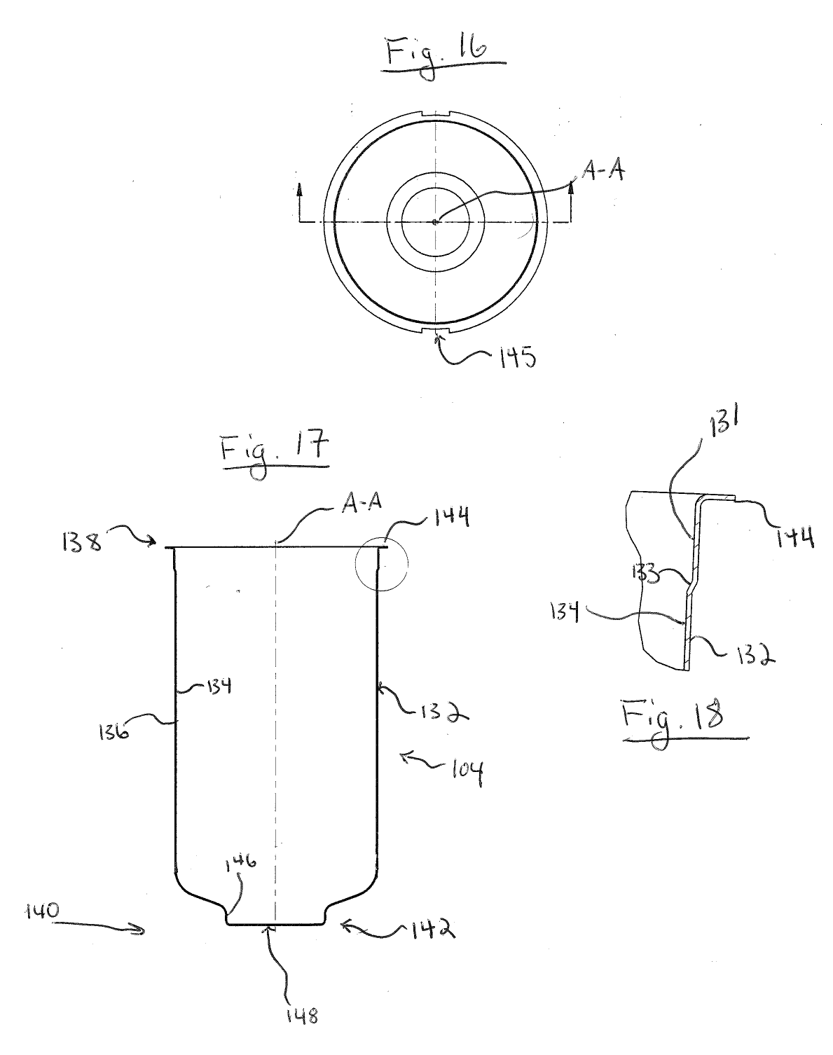

An inner surface 200 of the washer 150 is configured to mate with the valve (not shown). As shown in FIGS. 13 and 15, the inner surface 200 may define one half of a threaded connector system. Alternatively, a bayonet connector system (not shown) may be utilized to connect the valve to the washer 150.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A filter cartridge having a longitudinal axis for use with a filter base, said cartridge comprising:
a housing having a generally cylindrical sidewall coaxial with the longitudinal axis and defining an open first end and an axially opposite second end, said sidewall having inner and outer surfaces, and a flange projecting radially away from said outer surface of said housing at said open first end;
a filter element having a ring of filter media circumscribing the longitudinal axis and extending axially between first and second end caps, said first end cap defining a fluid flow opening coaxial with the longitudinal axis, a generally cylindrical wall disposed at a circumferential periphery and extending axially between first and peripheral rims, said cylindrical wall defining first and second seal glands adjacent said first and second peripheral rims, respectively, said seal glands oriented radially away from the longitudinal axis and receiving first and second seal members, respectively, a ledge projects radially outwardly from said cylindrical wall intermediate said first and second peripheral rims;
a collar having an annular sidewall having first and second axial ends, a circumferential shoulder projecting from an inner surface of said sidewall intermediate said first and second axial end and configured such that said ledge and shoulder radially overlap and retain the flange therebetween said collar circumscribing said housing and engaged with said first end cap such that said flange is axially retained between said ledge and said shoulder.

2. The filter cartridge of claim 1, wherein said first axial end of said collar defines axial slots separating a plurality of snap fingers said snap fingers having one of either a male or a female snap connector portion and an outer surface of said first end cap cylindrical wall having the other of the male or female snap connector portion.

3. The filter cartridge of claim 2, wherein a male snap connector portion projects from said snap fingers radially toward the longitudinal axis, and the female connector portion is defined on said outer surface of said cylindrical wall and oriented radially away from the longitudinal axis.

4. The filter cartridge of claim 2, wherein a male snap connector portion projects radially away from an outer surface of said first end cap cylindrical wall and said snap fingers defines a female snap connector portion oriented radially toward the longitudinal axis.

5. The filter cartridge of claim 1, wherein said annular sidewall has an inner surface defining a female portion of a mateable threaded connector system, and a male portion of said mateable threaded projects from an outer surface of said first end cap cylindrical wall adjacent said first peripheral rim.

6. The filter cartridge of claim 5, the collar defines axial slots between a plurality of snap fingers said snap fingers having one of either a male or a female snap connector portion and an outer surface of said first end cap cylindrical wall having the other of the male or female snap connector portion, said snap connector preventing disengagement of said upper end cap from said collar when said threaded connector system is in a fully engaged configuration.

7. The filter cartridge of claim 1, wherein said collar inner surface has an axially-oriented surface extending between first and second radially-oriented surfaces defining a circumferential pocket, said pocket disposed intermediate said first and second axial ends, said second radially-oriented surface contiguous with said circumferential shoulder, said pocket receives a wave spring undulating between a plurality of crests and a plurality of troughs configured to secure said wave spring at least partially radially within said pocket such that said wave spring crests also engage said ledge and said troughs engage said flange to provide axial forces securing said housing against said shoulder.

8. The filter cartridge of claim 1, wherein a plurality of tabs project radially outwardly from said cylindrical wall adjacent said ledge, said collar defines a corresponding plurality of axially-oriented slots and a circumferential pocket intermediate said first and second axial ends and communicating with said axial slots, a plurality of barbs project axially into said pocket adjacent each slot, each of said barbs having a ramp surface and a retention shoulder, and wherein rotating said upper end cap with respect to said collar such that said tabs ride up said ramp and past said retention shoulder reversibly secures said filter element within said housing.

9. The filter cartridge of claim 1, wherein said housing second end defines a drain having generally cylindrical sides and defining a drain port coaxial with the longitudinal axis, a plurality of supports extend axially from said second end cap and connect axially opposite said second end cap with a generally cylindrical washer having a radially outwardly facing circumferential groove, said drain sides are crimped to engage said groove and axially retain said filter element within said housing, said collar defines an annular pocket intermediate said first and second annular sidewalls.

10. The filter cartridge of claim 1, wherein at least one anti-rotation member projects from said circumferential shoulder and said flange defines a corresponding aperture sized to receive said anti-rotation member and prevent said housing from rotating relative to said collar.

11. The filter cartridge of claim 1, wherein said first end cap cylindrical wall tapers from said first peripheral rim to said second peripheral rim and said collar annular sidewall tapers from said first axial end to said second axial end.

12. The filter cartridge of claim 1, wherein said housing sidewall projects slightly radially outwardly adjacent said open first end so as to provide a seat to support said cylindrical wall adjacent said second peripheral rim and a ring of said sidewall between said seat and said open first end creates a seal between said second seal member and said inner surface of said housing.

13. The filter cartridge of claim 1, wherein an annular inner wall projects axially from said first end cap adjacent said fluid flow opening, said inner wall disposed radially inwardly of and concentric with said cylindrical wall and having a third seal gland oriented radially away from said longitudinal axis and configured to receive a third seal member, said third seal gland defined axially so as to create a third seal with a filter base fuel conduit disposed radially inwardly of a skirt.

14. A filter element having a longitudinal axis for use with a cartridge housing having a generally cylindrical sidewall having inner and outer surfaces and defining an open first end and an axially opposite second end, said filter element configured for use with a filter base, the filter element comprising:
a ring of filter media circumscribing the longitudinal axis and extending axially between filter media first and second ends;
a first end cap defining a fluid flow opening coaxial with said longitudinal axis, having first end cap first and second surfaces extending radially between a circumferential periphery and said fluid flow opening, an annular wall at said periphery and extending axially between first and second peripheral rims, said annular wall defining a first seal gland adjacent said first peripheral rim oriented radially away from the longitudinal axis and receiving a first seal member, said seal gland and seal member configured to create a seal with said base, said filter media first end secured to said first end cap second surface radially inwardly of said second annular wall;
an imperforate second end cap secured to said filter media second end.

15. The filter element of claim 14, wherein said annular wall defines a second seal gland adjacent said second peripheral rim oriented radially away from the longitudinal axis and receiving a second seal member, said second seal member forming a seal between said first end cap and the inside surface of the housing.

16. The filter element of claim 14, wherein an annular inner wall projects axially from said first surface adjacent said fluid flow axis, said inner wall disposed radially inwardly of and concentric with said cylindrical wall and having a seal gland oriented radially away from said longitudinal axis and configured to receive a seal member, said seal defined axially so as to create a seal with a filter base fuel conduit disposed radially inwardly of a skirt.

17. The filter element of claim 14, wherein a plurality of supports project axially away from said second end cap and connect axially opposite said second end with a generally cylindrical washer having a radially outwardly facing circumferential groove and sized to be received within generally cylindrical sides of a drain defined at the second end of the housing.

18. A method of using a filter cartridge with a filter base comprising:
dismounting the filter cartridge from the filter base by uncoupling a connection between a collar surrounding an open first end of a filter cartridge housing and a skirt of the filter base thereby breaking a first seal between a first seal member retained in a first seal gland of a first end cap and oriented radially away from a longitudinal axis of the filter cartridge and an inner surface of the filter base skirt;
disengaging said first end cap and said collar thereby breaking a seal between a second seal member and an inner surface of a cylindrical sidewall of said housing;
axially withdrawing said element from said housing;
axially inserting a replacement element within said housing;
engaging a ledge projecting radially away from a generally cylindrical wall of a first end cap of said replacement element with a shoulder projecting radially inwardly from an inner surface of said collar and thereby trapping a flange projecting radially away from an outer surface of said cartridge housing adjacent said open first end between said ledge and said shoulder, and creating said second seal between said second seal member and said inner surface;
remounting said filer cartridge to said filter base by coupling said connection between said collar and said filter skirt, creating said first seal between said first seal member and said inner surface of said skirt.

19. The method of claim 18, wherein the dismounting and remounting steps respectively comprise unthreading and rethreading a first threaded connection between an outer surface of said collar and said inner surface of the filter base.

20. The method of claim 18, wherein the dismounting and remounting steps respectively comprise connecting and disconnecting a first bayonet connection between an outer surface of said collar and said inner surface of the filter base.

21. The method of claim 18, wherein the dismounting and remounting steps respectively comprise breaking and creating a third seal between a third seal gland defined on an outer surface of an inner annular wall disposed radially inwardly of and concentric with said cylindrical wall and an inner surface of a fuel conduit disposed radially inwardly of said skirt.

22. The method of claim 18, wherein the disengaging and engaging steps respectively comprise disconnecting and connecting a second threaded connection between said first end cap and an inner surface of said collar, said collar inner surface having one of either a male or female threaded connector portion, and said first end cap having the other of said male or said female threaded connector portion on an outer surface of said first end cap cylindrical wall.

23. The method of claim 22, wherein the engaging step involves rotating said collar to connect said threaded connection until at least one detent carried by one of the collar first axial end or the first end cap cylindrical wall engages at least one receptacle defined on the other of the collar first axial end or the first end cap cylindrical wall, thereby preventing disconnection of the threaded connection.

24. The method of claim 18, wherein the engaging step comprises inserting a plurality of tabs projecting radially from said cylindrical wall adjacent said ledge into corresponding axially-oriented slots defined on an inner surface of said collar, pushing said first end cap until said tabs are received in a circumferential pocket defined intermediate first and second axial ends of said collar, and rotating said first end cap until said tabs ride up an engagement ledge and past a retention shoulder of a barb projecting into said pocket.

25. The method of claim 24, wherein the removing step comprises pushing said first end cap axially toward a second axial end of said housing causing said first end cap ledge to compress a wave spring received in a circumferential pocket defined intermediate said collar first and second axial ends and rotating said first end cap such that said tabs move past said retention shoulder and removing said tabs from said axially-oriented slots.
